(19) United States
(12) Patent Application Publication
(10) Pub. No.: US 2006/0229903 A1
(43) Pub. Date: Oct. 12, 2006

(54) Project-planning method and system

(76) Inventor: Wen-Hsien Chen, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/391,406

(22) Filed: Mar. 29, 2006

(30) Foreign Application Priority Data
Mar. 30, 2005 (TW) 094110149
Mar. 27, 2006 (TW) 095110576

(51) Int. Cl. G06Q 99/00

(52) U.S. Cl. 705/1

(57) ABSTRACT

A method for planning a project comprises a step of distributing the project and the step of distributing the project includes a step of planning a master project, which is established by a master project initiator who inputs information about the master project to an information processing device which notifies a master project successor of the master project automatically after the master project successor is set, and the master project successor determines whether the master project is distributed after the master project successor is notified of the master project by the information processing device and inputs the determination of the master project to the information processing device; a step of planning subprojects is further comprised, and after subproject successors are notified of the subprojects by the information processing device respectively, the subproject successors input the determination of each of the subprojects to the information processing device; a step of setting predecessor tasks, wherein the step of setting predecessor tasks is to set and build prerequisite relationships between the tasks synchronously according to the step of distributing the project; a step of setting task structures, wherein the information processing device automatically sets the task structures according to the information from the step of distributing the project; and a step of planning task schedules, wherein the information processing device automatically plans project schedules according to the information from the steps of distributing the project and setting the task structures.

### BACKGROUND OF INVENTION

1. Field of Invention

The present invention relates to a method and a system for planning a project and, more specifically, to a method and a system for planning a project through an information processing device to automatically plan and distribute the project.

2. Related Prior Art

As information based technologies continue to advance at unprecedented speed, the development of new products, the expansion of new markets, the improvement of infrastructures, operation processes and installation of information systems are often planned through setting projects. A good project management process or practice should allow the task flows and organization chart to be adjusted and adapted flexibly, in accordance to the real circumstances and changes unknown at the planning phase, to accomplish the defined project goals at predictable costs and resources.

Disclosed in Taiwanese Patent 1224268 is a method for managing a project. A project structure is defined to generate with a plurality of project templates. A project is initiated based on the project templates. The project includes a plurality of milestones that form a net-like structure and a schedule for reaching the milestones. The project is scrutinized and signed. Individuals are assigned to deliver these milestones. Dynamic scheduling is applied to the project. For example, time cards are collected, and the status of the milestones is set and updated. Based on the status of the milestones and the schedule, in the net-like structure, a critical path method is used to forecast completion date, and to determine whether all of the milestones have been reached or not. If any milestone has not been reached, the collection of the time cards continues. It also checks whether any milestone is in need of reworking. If a milestone is in need of reworking, the collection of the time cards continues. A project manager must set the project structure, and there are a lot of project templates. A system manager stores the project templates in a database. The project manager sets the schedule and assigns individuals to the project. Various departments involved must scrutinize and sign the project. The system conducts scheduling. This prior art is not effective or efficient, and often time not working well in the real project management practice. The over complicated procedure in the prior art puts too much burden and requires too much time on many departments during the project planning phase, and the practice of this prior art often causes defined schedule delayed or resources wasted because of numerous overlapped tasks and inefficacy of the process, as well as too much unnecessary or inefficient communications between various departments. What is worse, once a task is changed, all the subsequent subtasks must be changed, thus causing burdens for the project management.

Disclosed in U.S. Pat. No. 5,765,140 is a dynamic method for managing a project. There is provided a time table for recording every person held responsibility for a task and his working hours. The time table can record every person's actual working hours, estimated working hours and absence. A project manager can use the time table to monitor the progress of every job and accordingly determine whether to adjust the contents of the tasks and the deployment of the personnel.

With conventional project-planning software programs, when many persons synchronously conduct the planning of a main project and derivative projects, they cannot synchronously set the sequence of all of the tasks of the main and derivative projects and hence cannot adjust swiftly and accurately the task structure and the schedule.

It has been found that the above-mentioned references cannot reduce the gap between the planning and actual execution of the project. This mainly because the project manager and task managers from the related departments plan the project according to their management experience, but do not have enough details and resources required in the project execution, while the persons responsible in the execution are missing from the loop of project planning and tracking. As a consequence the original plan often time cannot satisfy the real needs occurred in the execution. Moreover, in the case the project is either big in size or complicated in nature, the task structure set up could be incomplete, the distribution of the resources could be inappropriate, the forecast dates of completion of the tasks could be inaccurate, and the setting of the milestones could be inappropriate, it is particularly so if the planners of the project lack of adequate experience in the first place. All these defects mentioned lead to a successful execution of the project very hard or impossible. The prior art does not address the need or working capacities of the persons responsible for the execution of the tasks, and do not allow many persons to synchronously plan the main and derivative projects.

The present invention is intended to obviate or at least alleviate the problems encountered in prior art.

### SUMMARY OF INVENTION

An objective of the present invention is to provide a method and a system for planning a project. Through the method of distributing the project and an information processing device, a master project of the project is distributed into one or plural subprojects connected with the master project. Task structures and task schedules are set and planned after the project is distributed. In the present invention, a project successor of every tier only needs to define the content of the job, outputs designated, time required and whether it is necessary to further distribute the project. If one or plural further projects distribution is necessary, the project successor only needs to define a title, successor and relevant information about every further subproject. Compared with the foregoing conventional methods for planning projects, the method of the present invention is more efficient in planning the projects without involving the project manager and the administrator of every tier.

Another objective of the present invention is to provide a method and a system for planning a project. Through the method of distributing the project and an information processing device, actual task executives can participate in planning the project, defining job methods, steps, and resource requirements, so as to conform to requirements of the actual executives during a planning stage. Accordingly, the present invention not only can improve accuracy of the project planning but also can reduce discrepancies between planning and execution.

Another objective of the present invention is to provide a method and a system for planning a project. Through a capacity for synchronously setting the sequence of all of the tasks of the project when many persons conduct the planning of a main project and derivative projects, task strictures and task schedules can be completed seamlessly.

A further objective of the present invention is to provide a method and a system for planning a project. Through setting control points, the task schedules can be modified synchronously.

More particularly, a method of the present invention for planning a project comprises:
distributing the project, wherein the step of distributing the project includes:
   planning a master project, wherein the step of planning the master project includes establishing the master project by a master project initiator; inputting information about the master project to an information processing device according to the step of establishing the master project; and notifying a master project successor of the master project automatically by the information processing device after the master project successor is set;
   determining whether the master project is distributed after the master project successor is notified of the master project by the information processing device; and inputting the determination of the master project to the information processing device;
      if it is determined that the master project is distributed, the master project successor plans one or plural subprojects; inputs information about every subproject distributed to the information processing device; and sets a subproject successor corresponding to the subproject; the information processing device automatically notifies the subproject successor of the subproject;
      if it is determined that the master project is not distributed, the master project successor inputs information about not to distribute the master project to the information processing device, which sets the master project as a final project automatically; and
   planning every subproject, wherein the step of planning the subproject includes determining whether any subproject is distributed after the subproject successor is notified of the subproject by the information processing device; and inputting the determination of the subproject to the information processing device;
      if it is determined that any subproject is distributed, the subproject successor plans one or plural extended subprojects from the subproject; inputs information about every extended subproject distributed to the information processing device; and sets an extended subproject successor corresponding to the extended subproject; and the information processing device automatically notifies the extended subproject successor of the extended subproject, and repeats the step of planning the subproject;
      if it is determined that any subproject is not distributed, the subproject successor inputs information about not to distribute the subproject to the information processing device, which automatically sets the subproject as a final project, and detects whether all subprojects are set as final projects; and if it is detected that all subprojects are not set as final projects, the step of planning the subproject is repeated until all subprojects are set as final projects;
setting predecessor tasks, wherein the step of setting the predecessor tasks is to set and build prerequisite relationships between the tasks synchronously according to the step of distributing the project;
setting task structures, wherein the information processing device automatically sets the task structures according to the information from the step of distributing the project; and
planning task schedules, wherein the information processing device automatically plans project schedules according to the information from the steps of distributing the project and setting the task strictures.

According to the method of the present invention, in the step of planning the master project, if it is determined that the master project is distributed, the subproject successors of the subprojects can be set by following methods. Firstly, the master project successor can directly set the subproject successors. Secondly, the subproject successors can be set by the information processing device automatically. Last, the subproject successors can be set by the information processing device in advance and be modified by the master project successor as needed.

According to the method of the present invention, in the step of planning the subproject, if it is determined that any subproject is distributed, the extended subproject successors of the extended subprojects can be set by following methods. Firstly, the subproject successor can directly set the extended subproject successors. Secondly, the extended subproject successors can be set by the information processing device automatically. Last, the extended subproject successors can be set by the information processing device in advance and be modified by the subproject successor as needed.

According to the method of the present invention, in the steps of planning the master project and the subprojects, a partial task can be reserved for and accomplished by the master project successor or the subproject successors respectively, and be identified as a final project.

According to the method of the present invention, the information processing device is a device selected from a group consisting of a computer, a personal digital assistant, a WAP and a mobile phone for processing and communicating information.

According to the method of the present invention, the method further comprises a step of setting predecessor tasks that is to set and build prerequisite relationships between the tasks of the master project and the subprojects synchronously.

According to the method of the present invention, the method further comprises a step of setting control points for the project. The control points can be set by following methods. Firstly, the master project initiator and the project successors can set the control points by themselves. Secondly, the control points can be set by the information processing device automatically according to the task structures and relevant information. Last, the control points can be set by the information processing device according to the task structures and relevant information in advance, and be modified by the master project initiator and the project successors as needed.

After modifying, the control points for the project can be synchronously updated to generate the task schedules by the information processing device.

According to the method of the present invention, the method further comprises a step of generating instantaneously task paths or project structures. During the project planning, a system can display the task paths or the project structures for the master project successor, the subproject successors and any of the project participants.

According to the method of the present invention, the master project, the subprojects and the final projects are stored in a project database for filing and planning.

According to the method of the present invention, the final projects include final project tasks, which are stored in a task database after the final project tasks are planned. The task database is provided for assigning and planning project tasks.

According to the method of the present invention, the step of distributing the project further includes a step of setting a parameter N, which represents a reference value to numbers of the project for the step of distributing the project in a database. The parameter N can be any natural number, such as 0, 1, 2, 3, . . . , and N.

Furthermore, a system of the present invention for planning a project, more particularly, planning the project according to master/sub project structures, and the system comprises:
an information processing device, provided for executing the system;
an executing program, installed in the information processing device to execute the project planning, wherein the project planning is executed by a method which comprises:
distributing the project, wherein the step of distributing the project includes:
   planning a master project, wherein the step of planning the master project includes establishing the master project by a master project initiator; inputting information about the master project to an information processing device according to the step of establishing the master project; and notifying a master project successor of the master project automatically by the information processing device after the master project successor is set;
   determining whether the master project is distributed after the master project successor is notified of the master project by the information processing device; and inputting the determination of the master project to the information processing device;
      if it is determined that the master project is distributed, the master project successor plans one or plural subprojects; inputs information about every subproject distributed to the information processing device; and sets a subproject successor corresponding to the subproject; the information processing device automatically notifies the subproject successor of the subproject;
      if it is determined that the master project is not distributed, the master project successor inputs information about not to distribute the master project to the information processing device, which sets the master project as a final project automatically; and
   planning every subproject, wherein the step of planning the subproject includes determining whether any subproject is distributed after the subproject successor is notified of the subproject by the information processing device; and inputting the determination of the subproject to the information processing device;
      if it is determined that any subproject is distributed, the subproject successor plans one or plural extended subprojects from the subproject; inputs information about every extended subproject distributed to the information processing device; and sets an extended subproject successor corresponding to the extended subproject; and the information processing device automatically notifies the extended subproject successor of the extended subproject, and repeats the step of planning the subproject;
      if it is determined that any subproject is not distributed, the subproject successor inputs information about not to distribute the subproject to the information processing device, which automatically sets the subproject as a final project, and detects whether all subprojects are set as final projects; and if it is detected that all subprojects are not set as final projects, the step of planning the subproject is repeated until all subprojects are set as final projects;
setting predecessor tasks, wherein the step of setting the predecessor tasks is to set and build prerequisite relationships between the tasks synchronously according to the step of distributing the project;
setting task structures, wherein the information processing device automatically sets the task structures according to the information from the step of distributing the project; and
planning task schedules, wherein the information processing device automatically plans project schedules according to the information from the steps of distributing the project and setting the task strictures.

According to the system of the present invention, in the step of planning the master project, if it is determined that the master project is distributed, the subproject successors of the subprojects can be set by following methods. Firstly, the master project successor can directly set the subproject successors. Secondly, the subproject successors can be set by the information processing device automatically. Last, the subproject successors can be set by the information processing device in advance and be modified by the master project successor as needed.

According to the system of the present invention, in the step of planning the subproject, if it is determined that any subproject is distributed, the extended subproject successors of the extended subprojects can be set by following methods. Firstly, the subproject successor can directly set the extended subproject successors. Secondly, the extended subproject successors can be set by the information processing device automatically. Last, the extended subproject successors can be set by the information processing device in advance and be modified by the subproject successor as needed.

According to the system of the present invention, the information processing device is a device selected from a group consisting of a computer, a personal digital assistant, a WAP and a mobile phone for processing and communicating information.

According to the system of the present invention, the executing program is implemented as one of software and firmware.

According to the system of the present invention, in the steps of planning the master project and the subprojects, a partial task can be reserved for and accomplished by the master project successor or the subproject successors respectively, and be identified as a final project.

According to the system of the present invention, the method further comprises a step of setting predecessor tasks that is to set and build prerequisite relationships between the tasks of the master project and the subprojects synchronously.

According to the system of the present invention, the method further comprises a step of setting control points for the project. The control points can be set by following methods. Firstly, the master project initiator and the project successors can set the control points by themselves. Secondly, the control points can be set by the information processing device automatically according to the task structures and relevant information. Last, the control points can be set by the information processing device according to the task structures and relevant information in advance, and be modified by the master project initiator and the project successors as needed.

After modifying, the control points for the project can be synchronously updated to generate the task schedules by the information processing device.

According to the system of the present invention, the method further comprises a step of generating instantaneously task paths or project structures. During the project planning, the system can display the task paths or the project structures for the master project successor, the subproject successors and any of the project participants.

According to the system of the present invention, the master project, the subprojects and the final projects are stored in a project database for filing and planning.

According to the system of the present invention, the final projects include final project tasks, which are stored in a task database after the final project tasks are planned. The task database is provided for assigning and planning project tasks.

According to the system of the present invention, the step of distributing the project further includes a step of setting a parameter N, which represents a reference value to numbers of the project for the step of distributing the project in a database. The parameter N can be any natural number, such as 0, 1, 2, 3, . . . , and N.

### BRIEF DESCRIPTION OF DRAWINGS

The present invention will be described through below illustration of the preferred embodiment referring to the drawings.

FIG. 1 is a flow chart of a method for planning a project according to the preferred embodiment of the present invention.

FIG. 2 is a block diagram for showing the relationship between a master project, subprojects and final projects.

FIG. 3 is a block diagram for showing the contents of the master project and the final projects.

FIG. 4 is a table for showing connections between the final projects and tasks.

FIG. 5 is a table for showing the contents of the tasks of the final projects.

FIG. 6 is a flow chart of final task structure.

FIG. 7 is a flow chart, showing predecessor tasks.

FIG. 8 is a flow chart, showing predecessor tasks.

### DETAILED DESCRIPTION OF PREFERRED EMBODIMENT

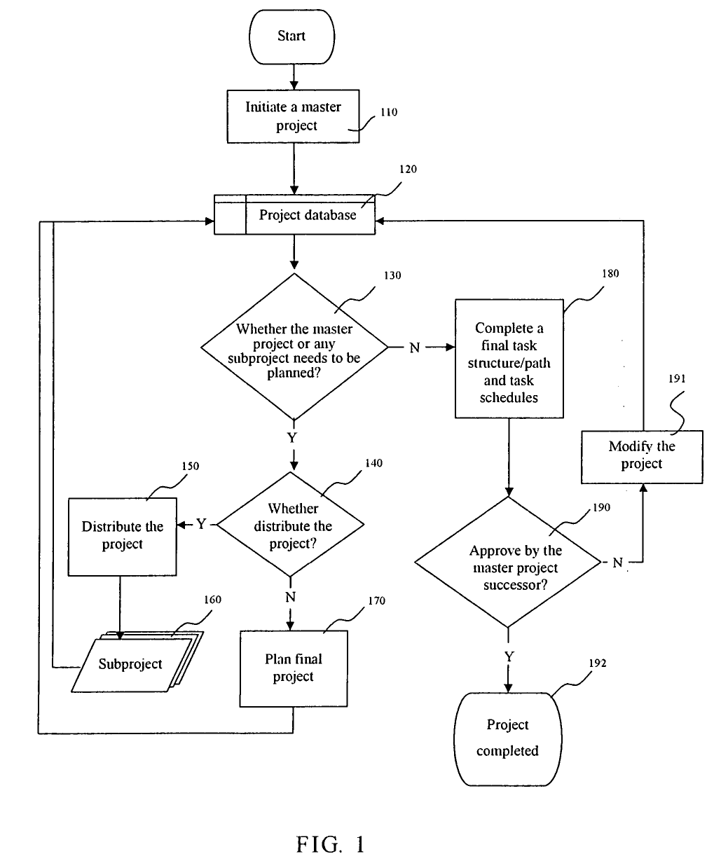

Referring to FIG. 1, shown is a method for planning a project as a preferred embodiment of the present invention, more particularly, planning the project according to master/sub project structures. The method of the present invention comprises a step of distributing the project that includes following steps. At step 110, a master project is planned and established by a master project initiator. The master project includes a title, the master project initiator, a master project successor, a deadline for the project planning, a deadline for the project execution, tasks of the master project and predecessor tasks. At step 140, after receiving a notification from the information processing device, the master project successor determines whether the master project is distributed and inputs a determination of the master project to the information processing device. At step 150, if it is determined that the master project is distributed, the master project successor plans one or plural subprojects and inputs information about every subproject distributed to the information processing device; and sets a subproject successor corresponding to the subproject. After the subproject successor is set, the information processing device notifies the subproject successor of the subproject automatically and respectively. According to the method of the present invention, the subproject successors can be set by following methods. Firstly, the master project successor can directly set the subproject successors. Secondly, the subproject successors can be set by the information processing device automatically. Last, the subproject successors can be set by the information processing device in advance and be modified by the master project successor as needed. At step 170, if it is determined that the master project is not distributed, the master project successor defines job content of the master project and then inputs the determination and information about not to distribute the master project to the information processing device which automatically sets the master project as a final project. After distributing the master project, the subprojects are connected with the master project. Additionally, the master project, the subprojects, if any, and any relevant final project are stored in a project database 120 so as to assist in further project distribution. After the master project is distributed, a further step of planning every subproject can be determined if necessary. At step 150, after the subproject successors are notified of the subprojects by the information processing device respectively, any subproject successor can determine whether the subproject is distributed and further input a determination of the subproject to the information processing device. If it is determined that the subproject is distributed, the subproject successor plans one or plural extended subprojects from the subproject, input the determination and information about every extended subprojects to the information processing device, and then set an extended subproject successor to the extended subprojects. Accordingly, the information processing device notifies the extended subproject successor of the extended subprojects. In the method of the present invention, the step of planning the subproject is repeatable if necessary. Furthermore, the extended subproject successors can be set by following methods. Firstly, the subproject successor can directly set the extended subproject successors. Secondly, the extended subproject successors can be set by the information processing device automatically. Last, the extended subproject successor can be set by the information processing device in advance and be modified by the subproject successor as needed. At step 170, if it determined that any subproject is not distributed, the subproject successor inputs the determination and information about not to distribute the subproject to the information processing device which automatically sets the subproject as a final projects, and detects whether all subprojects are set as final projects. If it is detected that all subprojects are not set as final projects, the step of planning the subproject is repeated until all subprojects are descended to become final projects. In other words, the project is organized and distributed completely, only after all of the master project and the subprojects are fully descended to a set of final projects. After the step of distributing the project, a subsequent step is to set task structures, which is set by the information processing device automatically according to the information from the step of distributing the project. At step 180, task schedules are further planned. The information processing device automatically plans project schedules and paths according to the information from the steps of distributing the project and setting the task structures.

In another embodiment of the present invention, when the project is distributed, the master project can be planned first. The master project successor can further proceed with planning the subproject distributions and determine what scope to be involved in the project execution. If the master project successor wants to involve in the project execution, the master project successor can reserve a partial task to execute. At step 170, the reserved task is set as a final project and stored in the project database 120 accordingly. Then, the master project successor can plan the final project, and input the information about the final project. If the master project successor determines not to in the project execution or has planned the partial task to execute. At steps 140 and 150, the master project successor can distribute the project or the rest task of the project to one or plural subproject successors who can proceed with relevant corresponding project distributions. In the step of planning subproject, any subproject successor can determine not to distribute the subproject, which is set as a final project accordingly so as to plan the final project, at step 170. Alternatively, any subproject successors can also reserve some tasks of the subproject and set the reserved tasks as a final task. Accordingly, unreserved tasks of the subprojects can further be distributed as one or plural extended subprojects and proceed with the step of planning the subproject, at steps 150 and 160. The step of planning the subproject is repeatable until it is not necessary for distributing any subproject. In other words, when the master project and the subprojects are distributed and descended as a complete a set of final projects, the project distribution is completed. The information processing device is a device selected from a group consisting of a computer, a personal digital assistant, a WAP and a mobile phone for processing and communicating information.

The method of the present invention further comprises a step of setting and generating control points for the project. The control points can be set by following methods. Firstly, the master project initiator and the project successors can directly set the control points. Secondly, the control points can be set by the information processing device automatically according to the task strictures and relevant information. Last, the control points can be generated by the information processing device according to the task strictures and relevant information in advance, and be modified by the master project initiator and the project successors as needed.

After modifying, the control points for the project can synchronously update the task schedules.

In the foregoing embodiments, at step 150, the project database 120 sets a parameter N, for monitoring distributions of projects based on the situation of the distributions of the projects. The parameter N is used to indicate how many projects need to be planned. N may be zero or any natural number. When the master project is established, the N is set to be 1. When X subprojects or final projects are set, N is increased by X. Whenever one project is distributed, N is reduced by one. Whenever one final project is planned, N is reduced by one. For examples, when the master project successor distributes five subproject to five subprojects successors, and reserves some tasks to form as a final project, there are one master project, five subprojects and one final project, and N is set to be 7 (1 plus 6, including the reserved tasks). After the master project successor completes the master project distribution, N will be reduced by one and become 6. When the master project successor has completed the planning of the reserved tasks, which is set as the final project, N will be reduced by one and become 5. Thus, N will be increased or reduced until there is no master project or any subproject of the project in need for distributions. N represents the number of the final projects in need of planning. The system continues to plan the final projects until it is determined that N becomes zero at step 130. Now, the planning of the project has been completed, and there is no master project, any subproject or any final project of the project in need of planning. Thus, the distributions and planning of the projects are monitored in order to provide the system with information about whether master project, any subproject or any final project of the project is planned incompletely.

A fully distributed project comprises one or more final projects, which are stored in the project database 120, the subprojects or the final projects will include the title of the parent project, the title of the project, the project successor, the title of the tasks, the predecessor tasks and the estimated man hours.

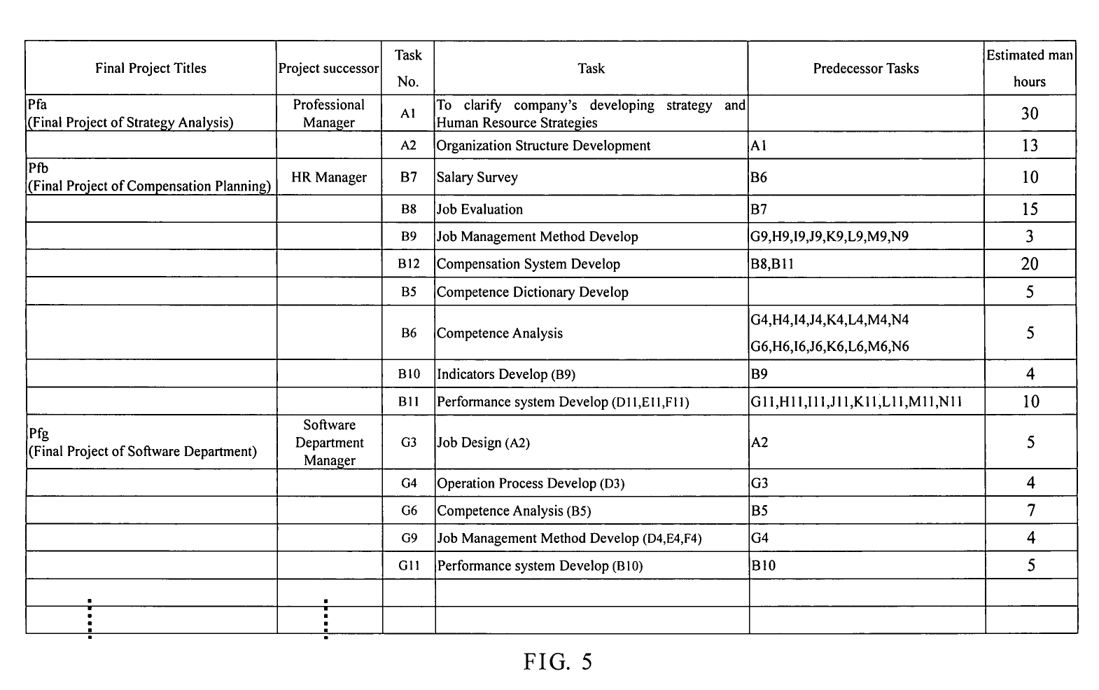

In the foregoing embodiment, according to the job content and connections between predecessor tasks and successor tasks of the final projects, a final project table is set accordingly. Referring to FIG. 5, according to connections among the predecessors and the final projects, task strictures are set. Accordingly, a chart of final task paths or a chart of project structures is generated and drawn, at step 180. When drawing the chart of the final task paths, the final task paths need not be developed along the same line, and various projects can be developed in parallel or in a cross-linked manner. As long as the connections between the predecessor task and the successor task of the tasks are scheduled in sequence correspondingly, such tasks can be set in the chart of the task paths, with no need in waiting for the completion of planning other project tasks. Therefore, synchronous planning of the projects is hence achieved. Moreover, the chart of the final task paths to a master project may include paths caused by one or more final projects, as long as the paths can be planned, the paths can be scheduled in a sequence, in parallel or in a cross-linked manner. Additionally, based on the estimated man hours of the final projects, available man hours of the project successors that are converted to dates of completion, and critical paths and control points found in the dates of completion from the paths, an overall task schedule is set at step 180. After setting of the task schedule, the task schedule needs to be examined by the master project successor at step 190. If it is considered that the planned project needs to be modified at step 191, the master project successor can modify the project and send the modified project into the project database 120; thereby the relevant successors of the subprojects or the final projects can determine whether to proceed with any distributions according to the modification or to retain the original structure by only changing the task content or task assignments. The master project successor shall approve and complete the project planning at steps 190 and 192.

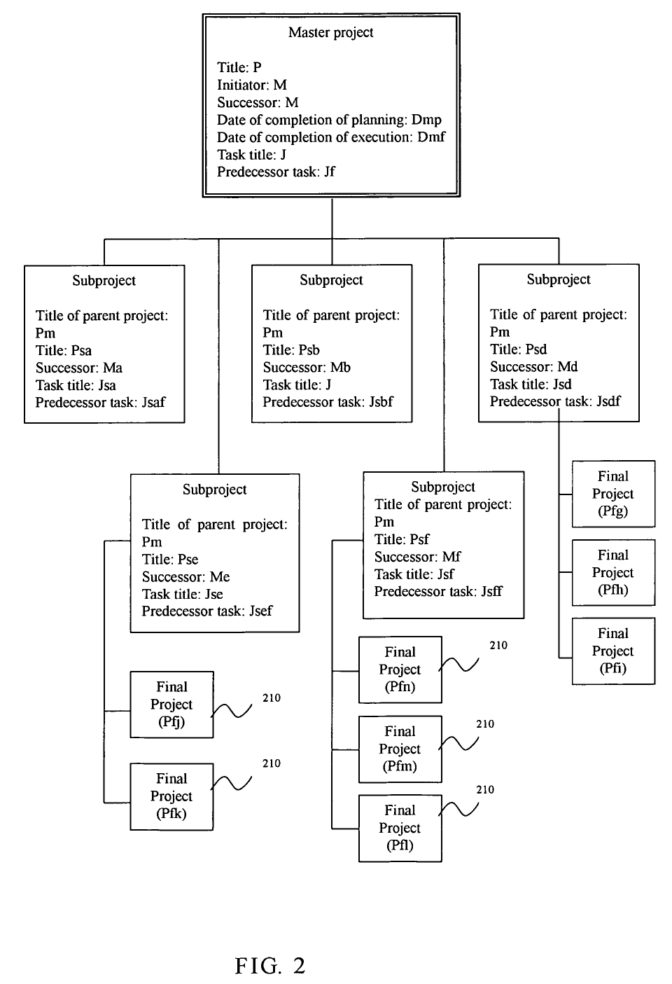

To make the features and advantages of the present invention better understood, a method according to a further embodiment of the present invention will be illustrated referring to FIG. 2.

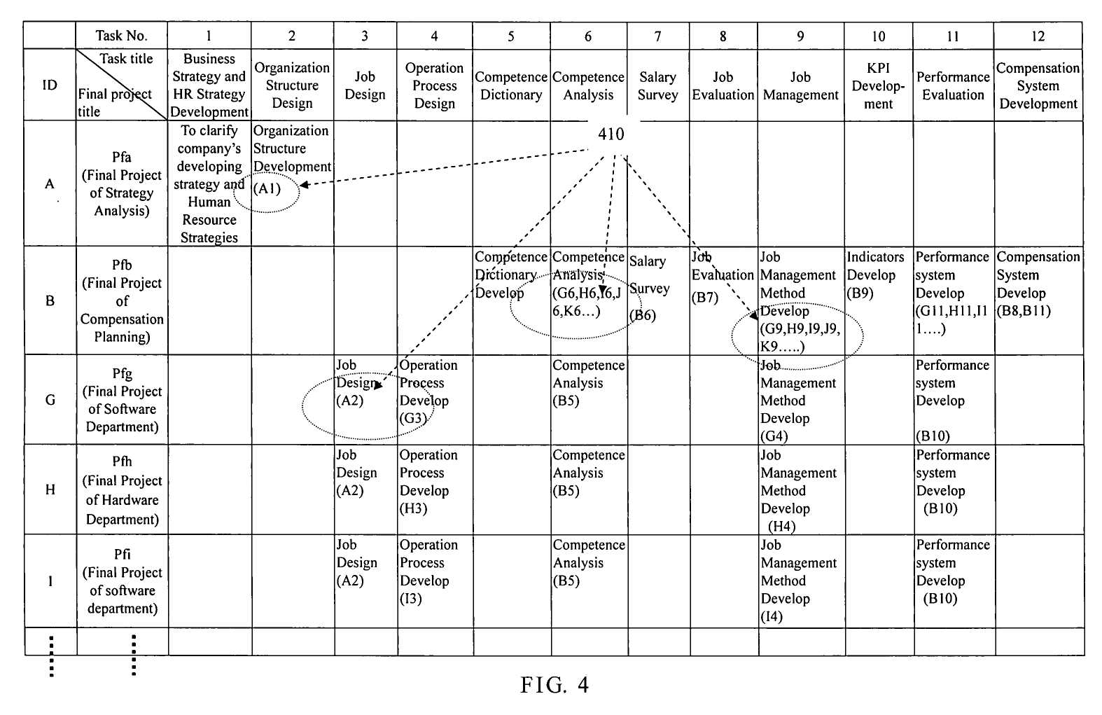

Based on various tasks of the project such as a Business Strategy and HR Strategy Development 1, Organization Structure Design 2, Job Design 3, Operation Process Design 4, Competence Dictionary 5, Competence Analysis 6, Salary Survey 7, Job Evaluation 8, Job Management 9, KPI Development 10, Performance Evaluation 11, and Compensation System Development 12, as shown in FIG. 4, a master project initiator M will needs to team up with several experts in various areas, such as professional manager Ma, Human Resource manager Mb, R&D manager Md, Marketing manager Me, General Affairs manager Mf, etc. according to the tasks of the project as suggested above.

In FIG. 2, the master project initiator M has established a master project P which is stored in the project database 120. The master project includes the content of a title P thereof, the initiator M, a successor M (same person as the initiator), date of completion of project planning Dmp, date of completion of project execution Dmf, a task title J and predecessor tasks Jf

Then, the master project successor M sets various subprojects and distributes the subprojects to the experts involved in the related fields of the subprojects. For examples, the master project successor M sets a Strategy Analysis subproject, which involves with Business Strategy and HR Strategy Development 1, as well as the Organization Structure Design 2, and then distributes the subproject to the manager Ma. The Strategy Analysis subproject includes the content of a parent title Pm, a title Psa, a successor Ma, a task title Jsa, and predecessor tasks Jsaf.

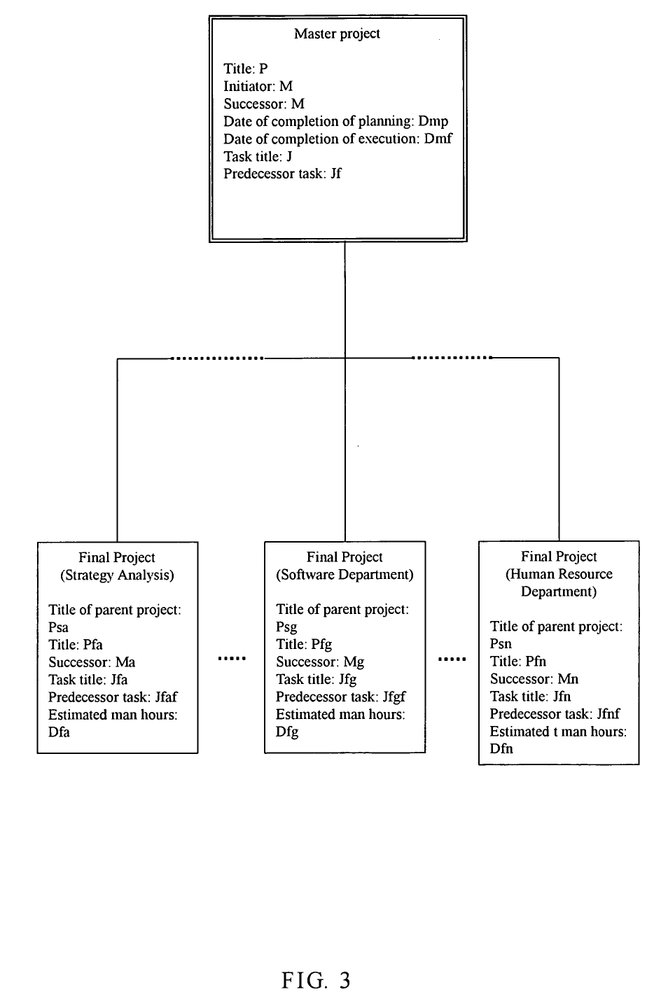

After receiving the subproject, the subproject successor can determine whether the subproject is distributed or not. As shown in FIG. 2, after receiving the subproject, the subproject successor Md is determined not to involve in the execution of the subproject. Instead, the subproject successor Md distributes the subproject to three extended subprojects and sets the extended subprojects to the managers Mg, Mh and Mi respectively. When the mangers Mg, Mh and Mi are determined not to distribute the extended subprojects to others, the extended subprojects are set as the final projects, namely Pfg, Pfh and Pfi, which are stored in the project database 120. When the subproject successor is determined not to further distribute the subproject, the subproject will be set as the final project 210. As shown in FIG. 3, the subproject successor Ma determines not to further distribute the subproject Psa, which becomes the final project Pfa. Therefore, the content of the subproject includes the parent title Pm, the title Psa, the successor Ma, the task title Jsa and the predecessor tasks Jsaf will be converted to the final project Pfa whose content includes the parent title Psa, the successor Ma, the task title Jfa (actually including A1 and A2 as shown in FIG. 4) and the predecessor tasks Jfaf respectively. Additionally, the estimated man hours Dfa is also set by the final project successor Ma.

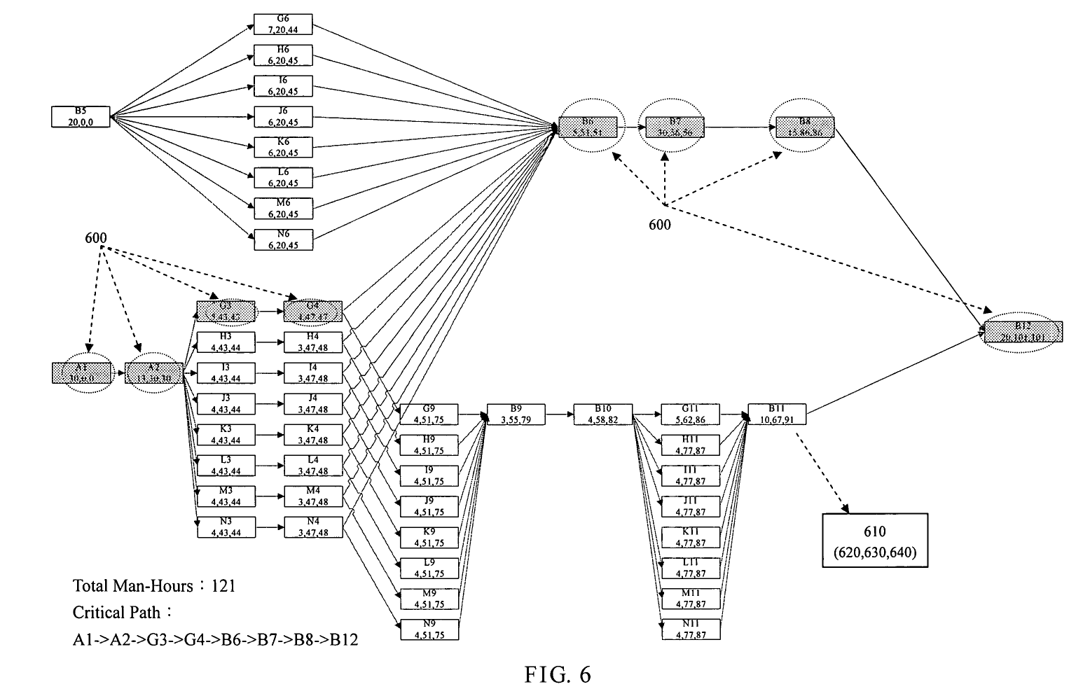

After the step of distributing the project and the foregoing paths have been completed, the system automatically completes the task structures according to information from the step of distributing the project. Additionally, based on a critical path method (CPM) and all the relevant information, the system draws the chart of the task paths, sets the control points, such as A1, A2, G3, G4, B6, B7, B8 and B12 as shown in FIG. 6, and notifies the master project successor of the control points. Accordingly, the master project successor M can examine the control points at step 190 so as to determine whether to approve the control points proposed by the system, as shown in FIG. 1, and to further determine positions of the control points. Alternatively, the master project successor can directly set the control points without referring to the proposed control points from the system.

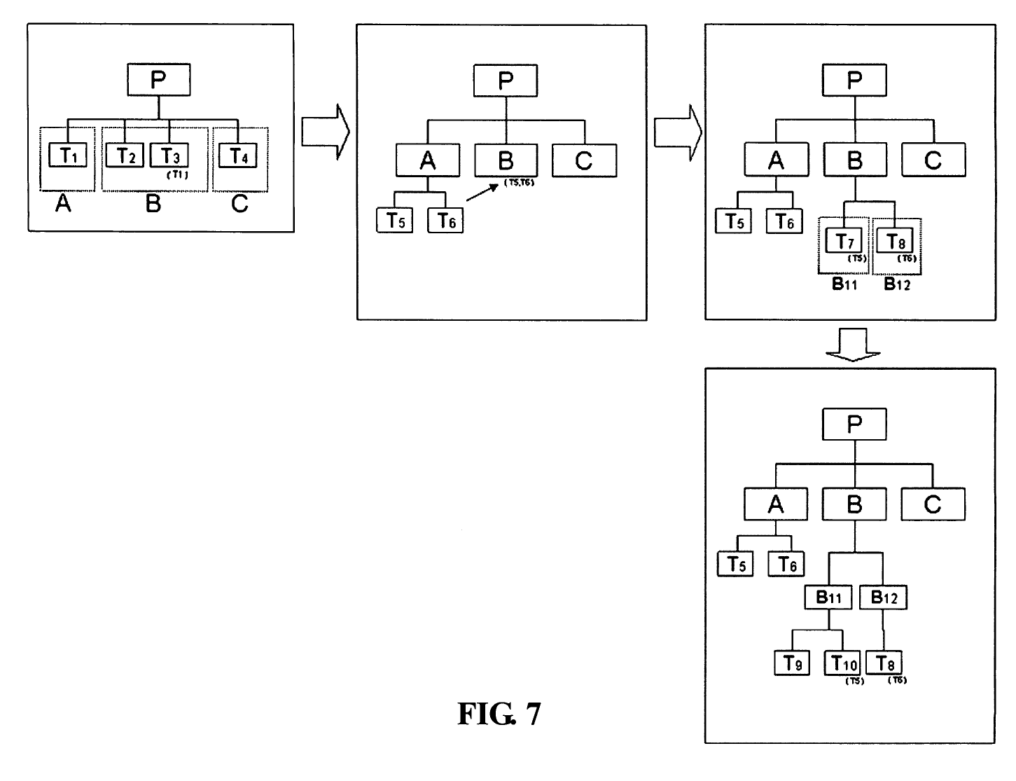

Referring to FIG. 7, a method according to a further embodiment of the present invention will be described so as to show how the predecessor tasks are set. The master project initiator has initiated the project P, and then the master project successor accordingly sets the project P to include tasks T1, T2, T3 and T4. The task T1 is set to be the predecessor task of the task T3. The master project successor distributes the task T1 to a successor and sets the task T1 as a subproject A. The tasks T2 and T3 are further distributed to another successor and are set as a subproject B. After receiving the subproject A, the subproject A successor decides not to distribute the subproject A and to set two tasks T5 and T6 in the subproject A. Then, the system will automatically notify the subproject B successor of assigning suitable predecessor tasks from the tasks T5 and T6. In the present embodiment, the subproject B successor succeeds both of the tasks T5 and T6, the system will convert the predecessor tasks of the subproject B to T5 and T6. Furthermore, the subproject B successor is distributed the subproject to two extended subprojects B11 and B12, and sets T5 as the predecessor task of the extended subproject B11 and the T6 as the predecessor task of the extended subproject B12. After receiving the subproject B12, the subproject B12 successor decides not to distribute the subproject B12, which is set as a final project and a task T8 is converted to a final project by the system. Additionally, the subproject B11 successor also determines not to distribute the subproject B11 but defines two tasks T9 and T10. Then, the system will require the subproject B11 successor to indicate which task should succeed the predecessor task T5. In this embodiment, the task T10 is set to succeed the predecessor task T5. Accordingly, the connections among the predecessor tasks are completed.

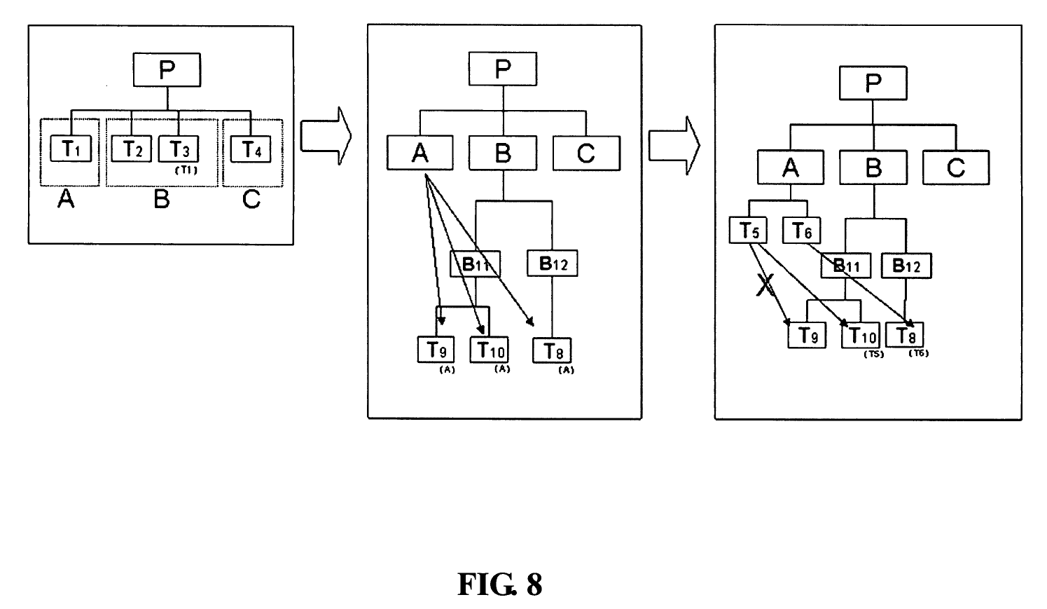

According to the above embodiment, FIG. 8 shows that if the subproject A is not planned, the subproject B can be planned without awaiting other corresponding projects and then set the predecessor tasks of the extended subprojects in connection with the subproject A as the subproject A. Once the subproject A is further acted, the system will automatically notify the final project successors who set the subproject A as the predecessor tasks and require them to assign new predecessor tasks according to latest status of the subproject A. In this embodiment, the subproject B11 successor has set the subproject A to be the predecessor tasks of both the tasks T9 and T10. After being notified of the new status of the subproject A by the system, the subproject B11 successor can set the task T5 to be the predecessor task of the task T10, and cancel the predecessor connection of the task T9 with the subproject A.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A method of the present for planning a project comprises:
distributing the project, wherein the step of distributing the project includes:
planning a master project, wherein the step of planning the master project includes establishing the master project by a master project initiator; inputting information about the master project to an information processing device according to the step of establishing the master project; and notifying a master project successor of the master project automatically by the information processing device after the master project successor is set;
determining whether the master project is distributed after the master project successor is notified of the master project by the information processing device; and inputting the determination of the master project to the information processing device;
if it is determined that the master project is distributed, the master project successor plans one or plural subprojects; inputs information about every subproject distributed to the information processing device; and sets a subproject successor corresponding to the subproject; the information processing device automatically notifies the subproject successor of the subproject;
if it is determined that the master project is not distributed, the master project successor inputs information about not to distribute the master project to the information processing device, which sets the master project as a final project automatically; and planning every subproject, wherein the step of planning the subproject includes determining whether any subproject is distributed after the subproject successor is notified of the subproject by the information processing device; and inputting the determination of the subproject to the information processing device;
if it is determined that any subproject is distributed, the subproject successor plans one or plural extended subprojects from the subproject; inputs information about every extended subproject distributed to the information processing device; and sets an extended subproject successor corresponding to the extended subproject; and the information processing device automatically notifies the extended subproject successor of the extended subproject, and repeats the step of planning the subproject;
if it is determined that any subproject is not distributed, the subproject successor inputs information about not to distribute the subproject to the information processing device, which automatically sets the subproject as a final project, and detects whether all subprojects are set as final projects; and if it is detected that all subprojects are not set as final projects, the step of planning the subproject is repeated until all subprojects are set as final projects;
setting predecessor tasks, wherein the step of setting the predecessor tasks is to set and build prerequisite relationships between the tasks synchronously according to the step of distributing the project;
setting task structures, wherein the information processing device automatically sets the task structures according to the information from the step of distributing the project; and
planning task schedules, wherein the information processing device automatically plans project schedules according to the information from the steps of distributing the project and setting the task structures.

2. The method according to claim 1, wherein in the steps of planning the master project and the subprojects, a partial task can be reserved for and accomplished by the master project successor or the subproject successors respectively, and be identified as a final project.

3. The method according to claim 1, further comprising a step of setting control points for the project, wherein the control points can be set by either the master project initiator and the project successors directly, or by the information processing device, which provides reference control points to allow the master project initiator, project successors determining whether to modify the control points.

4. The method according to claim 3, wherein the step of planning task schedules is modified synchronously, after the control points are set.

5. The method according to claim 1, further comprising a step of generating instantaneously task paths or project strictures, wherein during the project planning, a system can display the task paths or the project structures for the master project successor, the subproject successors and any project participants.

6. The method according to claim 5, the step of generating instantaneously task paths or project structures is arranged after the step of setting the task strictures or the step of planning the task schedules so as to control the project.

7. The method according to claim 1, wherein the master project, the subprojects, and the final projects are stored in a project database.

8. The method according to claim 1, wherein the final projects include final project tasks, which are stored automatically in a task database after the final project tasks are planned.

9. The method according to claim 1, wherein the step of distributing the project further includes a step of setting a parameter N, which is served as a reference value in a database to indicate numbers of the project that needs to be planned.

10. A system for planning a project, comprising:
an information processing device, provided for executing the system;
an executing program, installed in the information processing device to execute the project planning, wherein the project planning is executed by a method which comprises:
distributing the project, wherein the step of distributing the project includes:
planning a master project, wherein the step of planning the master project includes establishing the master project by a master project initiator; inputting information about the master project to an information processing device according to the step of establishing the master project; and notifying a master project successor of the master project automatically by the information processing device after the master project successor is set;
determining whether the master project is distributed after the master project successor is notified of the master project by the information processing device; and inputting the determination of the master project to the information processing device;
if it is determined that the master project is distributed, the master project successor plans one or plural subprojects; inputs information about every subproject distributed to the information processing device; and sets a subproject successor corresponding to the subproject; the information processing device automatically notifies the subproject successor of the subproject;
if it is determined that the master project is not distributed, the master project successor inputs information about not to distribute the master project to the information processing device, which sets the master project as a final project automatically; and
planning every subproject, wherein the step of planning the subproject includes determining whether any subproject is distributed after the subproject successor is notified of the subproject by the information processing device; and inputting the determination of the subproject to the information processing device;
if it is determined that any subproject is distributed, the subproject successor plans one or plural extended subprojects from the subproject; inputs information about every extended subproject distributed to the information processing device; and sets an extended subproject successor corresponding to the extended subproject; and the information processing device automatically notifies the extended subproject successor of the extended subproject, and repeats the step of planning the subproject;
if it is determined that any subproject is not distributed, the subproject successor inputs information about not to distribute the subproject to the information processing device, which automatically sets the subproject as a final project, and detects whether all subprojects are set as final projects; and if it is detected that all subprojects are not set as final projects, the step of planning the subproject is repeated until all subprojects are set as final projects;
setting predecessor tasks, wherein the step of setting the predecessor tasks is to set and build prerequisite relationships between the tasks synchronously according to the step of distributing the project;
setting task structures, wherein the information processing device automatically sets the task structures according to the information from the step of distributing the project; and
planning task schedules, wherein the information processing device automatically plans project schedules according to the information from the steps of distributing the project and setting the task structures.

11. The system according to claim 10, wherein the information processing device is a device selected from a group consisting of a computer, a personal digital assistant, a WAP and a mobile phone for processing and communicating information.

12. The system according to claim 10, wherein the executing program is implemented as one of software and firmware.

13. The system according to claim 10, wherein in the steps of planning the master project and the subprojects, a partial task can be reserved for and accomplished by the master project successor or the subproject successors respectively, and be identified as a final project.

14. The system according to claim 10, further comprising a step of setting control points for the project, wherein the control points can be set by either the master project initiator and the project successors directly, or by the information processing device, which provides reference control points to allow the master project initiator, project successors determining whether to modify the control points.

15. The system according to claim 14, wherein the step of planning task schedules is modified synchronously, after the control points are set.

16. The system according to claim 10, further comprising a step of generating instantaneously task paths or project structures, wherein during the project planning, a system can display the task paths or the project structures for the master project successor, the subproject successors and any project participants.

17. The system according to claim 16, the step of generating instantaneously task paths or project structures is arranged after the step of setting the task structures or the step of planning the task schedules so as to control the project.

18. The system according to claim 10, wherein the master project, the subproject, and the final projects are stored in a project database.

19. The system according to claim 10, wherein the final projects include final project tasks, which are stored automatically in a task database after the final project tasks are planned.

20. The system according to claim 10, wherein the step of distributing the project further includes a step of setting a parameter N, which is served as a reference value in a database to indicate numbers of the project that needs to be planned.
